(19) United States
(12) Patent Application Publication
(10) Pub. No.: US 2012/0170214 A1
(43) Pub. Date: Jul. 5, 2012

(54) DROP-IN MOUNTING STRUCTURE FOR COMPUTING COMPONENTS UTILIZING CONTACT CONNECTORS

(75) Inventor: CARL D. WILLIAMS, COLORADO SPRINGS, CO (US)

(73) Assignee: JABIL CIRCUIT, INC., ST. PETERSBURG, FL (US)

(21) Appl. No.: 12/982,380

(22) Filed: Dec. 30, 2010

(51) Int. Cl. G06F 1/16; H01R 43/00

(52) U.S. Cl. 361/679.58; 29/825

(57) ABSTRACT

A drop-in computing component mounting system can include a contact connector and two drop-in mounting arms. The contact connector can be configured to provide a solderless connection between a computing component and an element of a computing environment. The two drop-in mounting arms can be attached to a mounting surface of the element of the computing environment. The two mounting arms can be aligned in parallel to each other at a spacing corresponding to the dimensions of the computing component being mounted. Each mounting arm can include a quantity of fastening fingers. The quantity and positioning of the fastening fingers can correspond to the quantity and positioning of fastening indentations upon the computing component being mounted. Placement of the computing component between the two mounting arms can engage the fastening fingers with their corresponding fastening indentations and can engage the contact connector.

### BACKGROUND

The present invention relates to the field of electronic hardware and, more particularly, to a drop-in mounting structure for computing components utilizing contact connectors.

With electronic devices, particularly those having limited internal space (e.g., notebook computers, smart phones, etc.) for auxiliary components (e.g., storage elements and input/output elements), designing a configuration of computing components arranged on the device's primary element, typically a printed circuit board (PCB) (i.e., a computer motherboard), is often a complex and tedious task. A designer must take into account not only the electronic characteristics and wiring, but also the spatial requirements of the auxiliary computing components. This task goes beyond the simple puzzle of mounting the computing components on the surface of the primary element, since computing components often require additional space to complete the mounting process.

For example, when mounting a hard disk drive (e.g., any device having a hard drive form factor, which includes solid state drives and other peripheral devices) into a mounting structure on a PCB, the hard drive typically requires room to slide into the mounting structure and connect to the available communication port.

While this amount of additional space needed may seem insignificant, it can cause significant design issues with size-constrained electronic devices. In the attempt to minimize these issues, some manufacturers of auxiliary computing devices provide a proprietary system to place their components with little or no need for additional space. However, such proprietary systems are typically more expensive and do not allow for component interchangeability.

To address the wide variety of computing components, a specialized contact connector is described in U.S. Patent Application 21458/0212895 to reduce the coupling between the ports of the PCB and the computing component from mechanical to electrical via surface contact. While this contact connector helps to reduce additional space needed to couple ports, the additional space required to seat the computing component in its mounting structure is left unaddressed.

### BRIEF SUMMARY

One aspect of the present invention can include a computing component mounting system. Such a system can include a contact connector and two drop-in mounting arms. The contact connector can be configured to provide a solderless connection between a computing component and an element of a computing environment. The contact connector can include a contact adapter and a contact pad, where contact between the contact adapter and the contact pad can establish an electrical interface between the computing component and the computing environment. The two drop-in mounting arms can be attached to a mounting surface of the element of the computing environment. The two mounting arms can be aligned in parallel to each other at a spacing corresponding to the dimensions of the computing component being mounted. Each mounting arm can include a quantity of fastening fingers. The quantity and positioning of the fastening fingers can correspond to the quantity and positioning of fastening indentations upon the computing component being mounted. Placement of the computing component between the two mounting arms can engage the fastening fingers with their corresponding fastening indentations and can engage the contact connector.

Another aspect of the present invention can include a system for mounting computing components. Such a system can include an element of a computing environment having at least one connection port, a computing component having a connector corresponding to a connection port on the element of the computing environment, a contact connector, and a drop-in mounting structure. The contact connector can be configured to provide a solderless connection between the computing component and the element of the computing environment. The contact connector can include a contact adapter and a contact pad, where contact between the contact adapter and the contact pad establishes an electrical interface between the computing component and the computing environment. The drop-in mounting structure can be attached to a mounting surface of the element of the computing environment. The drop-in mounting structure can be configured to allow placement of the contact connector element attached to the computing component directly upon the contact connector element attached to the mounting surface of the element of the computing environment in a single motion perpendicular to the mounting surface.

Yet another aspect of the present invention can include a method for installing computing components that use contact connectors. Such a method can begin with placing a computing component within a drop-in mounting structure. The drop-in mounting structure can have two mounting arms. The two mounting arms can be aligned in parallel to each other at a spacing corresponding to dimensions of the computing component and can be attached upon a mounting surface of an element of a computing environment. Placement of the computing component can engage a contact connector between the computing component and the mounting surface. As such, an element of the contact connector attached to the computing component is directly situated upon a corresponding element of the contact connector attached to the mounting surface in one action.

### BRIEF DESCRIPTION OF THE SEVERAL VIEWS OF THE DRAWINGS

FIG. 1 is a schematic diagram of a system describing a drop-in mounting structure for mounting computing components in accordance with embodiments of the inventive arrangements disclosed herein.

FIG. 2 is a schematic diagram of a system illustrating a three-sided embodiment of the drop-in mounting structure in accordance with an embodiment of the inventive arrangements disclosed herein.

FIG. 2A is a schematic diagram illustrating the contact connector attached to the computing component for the three-sided embodiment of the drop-in mounting structure.

FIG. 3 is a schematic diagram of a system 300 illustrating a four-sided embodiment of the drop-in mounting structure in accordance with embodiments of the inventive arrangements disclosed herein.

FIG. 4 is a schematic diagram of a system illustrating a drop-in mounting structure with a latching mechanism in accordance with embodiments of the inventive arrangements disclosed herein.

FIG. 4A is a schematic diagram illustrating the computing component mounted and latched into the drop-in mounting structure.

FIG. 4B is a side view of a computer component mounted in a drop-in mounting structure with a latching mechanism.

FIG. 5 is a schematic diagram of a system illustrating a drop-in mounting for a computing device, which is secured through holes in the mounting surface.

FIG. 5A is a schematic diagram of an embodiment that shows a drive cage, where the cage is able to be contain the computing component.

FIGS. 6, 6A, 6B, and 6C shows a schematic diagram of a system showing a pivot mechanism for coupling a computing component 610 to a mounting surface 625 in accordance with an embodiment of the disclosure.

FIG. 7 shows a flow chart for coupling a computing component with a drop-in mounting structure in accordance with an embodiment of the inventive arrangements disclosed herein.

### DETAILED DESCRIPTION

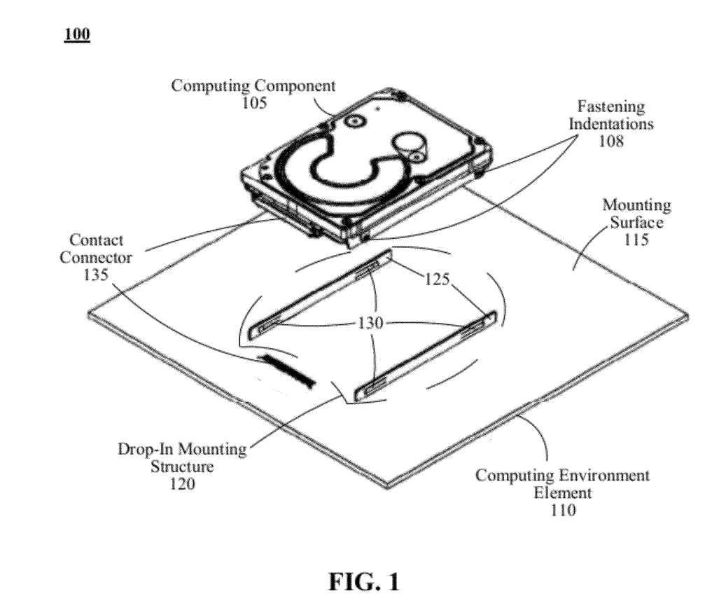

FIG. 1 is a schematic diagram of a system 100 describing a drop-in mounting structure 120 for mounting computing components 105 in accordance with embodiments of the inventive arrangements disclosed herein. In system 100, computing component 105 can be placed within the drop-in mounting structure 120 in one action. That is, placement of the computing component 105 within the drop-in mounting structure 120 from the direction perpendicular to the mounting surface 115 (i.e., dropped into the drop-in mounting structure 120 and onto the mounting surface 115) can immediately couple the computing component 105 to the computing environment element 110, without additional mounting actions such as lateral positioning (e.g., sliding).

Computing component 105 can represent a variety of devices, such as mass storage devices and video cards, designed to interface with the computing environment element 110. It should be noted that, although the computing component 105 illustrated in the Figures is shown as a hard disk drive, embodiments of the invention are not limited in this regard. As such, it should also be noted that other types of computing components 105 can require slight modifications to the elements of the drop-in mounting structure 120 without deviating from the intent of the present invention.

The computing components 105 can be items that are mass-produced by a variety of vendors. That is, the hard disk drive 105 shown in system 100 could represent any of such items commercially available for purchase from a variety of vendors. Typically, such computing component 105 can be manufactured to standard dimensions and can include fastening indentations 108 for mounting to a conventional mounting structure.

For example, most hard disk drives 105 can have screw holes 108 drilled into the housing during production. A user can be expected to utilize screws during the mounting process to secure the hard disk drive 105 to its mounting structure.

The computing environment element 110 can represent an item used to transmit electrical signals between the various components that create the computing environment. Typically, the computing environment element 110 can represent a printed circuit board (PCB) or another type of foundation element for the circuitry of the computing environment and/or communication between components of the computing environment. Within the Figures illustrating embodiments of the present invention, the computing environment element 110 will be referred to in terms applicable to a PCB.

The computing environment element 110 can have one or more mounting surfaces 115 upon which the various computing components 105, circuit elements, and the drop-in mounting structure 120 can be attached. The drop-in mounting structure 120 can represent a configuration of elements designed to allow the computing component 105 to be mounted upon the mounting surface 115 and an interface established with the computing environment element 110 in a single placement.

Multiple embodiments exist for mounting computing component 105 to the mounting surface 115. In one embodiment, the drop-in mounting structure 120 can include two mounting arms 125 that can be attached to the mounting surface 115. Each mounting arm 125 can be created to include one or more fastening fingers 130. The quantity and positioning of the fastening fingers 130 upon the mounting arms 125 can correspond to the quantity and positioning of the fastening indentations 108 of the computing component 105.

The fastening fingers 130 can represent a mechanism for securing the computing component 105 within the drop-in mounting structure 120 using the fastening indentations 108 already available upon the variety of computing components 105 that are manufactured to preset standards. As illustrated in system 100, each mounting arm 125 can include two fastening fingers 130, corresponding to the four fastening indentations 108 of the hard disk drive 105.

In this example, the fastening fingers 130 can be illustrated as prongs, each ending with a protrusion that can be inserted into the corresponding fastening indentations 108. The prongs can be tooled directly from the material of the mounting arms 125 or can be separate elements attached to the mounting arms 125. As the computing component 105 is placed downward (i.e., towards the mounting surface 115) between the mounting arms 125, the prongs 130 can retract (i.e., the housing of the computing component 105 pushes the prongs 130 back) until the protrusion can be fitted into the fastening indentation 108.

The mounting arms 125 can be positioned on the mounting surface 115 to accommodate the dimensions of the computing component 105 and allow the fastening fingers 130 to engage the fastening indentations 108. That is, the mounting arms 125 should not be placed in such a manner to provide additional room for the fastening fingers 130 or at a distance inappropriate for the computing component 105.

Further, the mounting arms 125 can be attached to the computing environment element 110 in a variety of ways in accordance with the materials utilized in both the mounting arms 125 and computing environment element 110.

Use of the drop-in mounting structure 120 can eliminate the need for additional fastening elements during the mounting process and additional space on the mounting surface 115 for seating the computing component 105, as in a conventional mounting structure. Additionally, computing components 105 of the same type but from different vendors can be used interchangeably with the drop-in mounting structure 120, as long as the computing components 105 are produced to the same standards.

Further, an aggregate of smaller computing components 105 can be mounted in a drop-in mounting structure 120 of a different size. For example, two 2.5-inch hard disk drives 105 can be aggregated in a framework to be mounted in a drop-in mounting structure 120 sized for a 3.5-inch hard disk drive 105.

The drop-in mounting structure 120 can provide even greater benefits in regards to maximizing layout space on the mounting surface 115 when the computing component 105 utilizes a contact connector 135, as described in U.S. Patent Application 21458/0212895, to interface with the computing environment element 110.

Because the contact connector 135 requires only surface contact between its elements, the computing component 105 can be seated within the drop-in mounting structure 120 without applying the additional force typically required to couple a mated pair of connectors. As such, the area of the mounting surface 115 under the computing component 105 can be utilized for placement of other components (e.g., wiring, resistors, capacitors, etc.) without fearing that they will be damaged when mounting the computing component 105.

Further, the additional space that would be required with a conventional mounting structure for seating the computing component 105 can also be reallocated for use by other components.

Although fastening fingers 130 are the shown mechanism for securing the computing component 105 to the drop-in mounting structure 120, other mechanism can be utilized in various contemplated embodiments of the disclosure. For example, in one embodiment, spring loaded pins can be used to slide into the fastening indentations 108. In another embodiment, screws can be passed through structure 120 into indentations 108 to secure component 105. In another embodiment, screws passing through the bottom of mounting surface 115 and into a surface of component 105 (the underside of component 105) can be used to secure component 105 to surface 115, in which case the mounting arms 125 can represent walls that prevent movement of component 105 and/or ensure its proper positioning and alignment relative to surface 115.

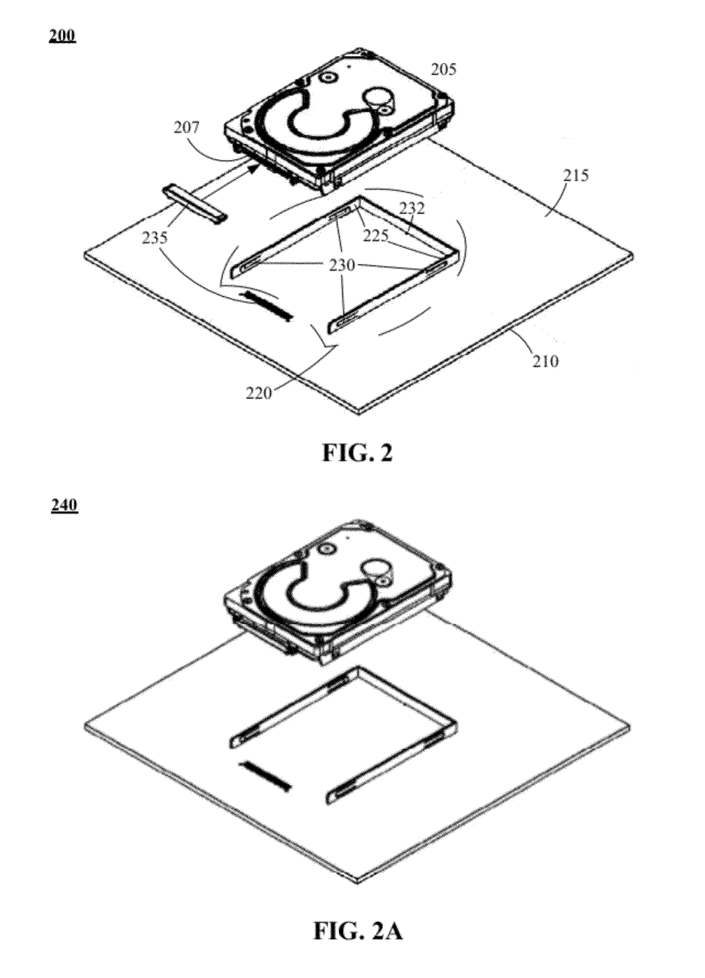

FIG. 2 is a schematic diagram of a system 200 illustrating a three-sided embodiment of the drop-in mounting structure in accordance with embodiments of the inventive arrangements disclosed herein. System 200 can represent a specific embodiment of system 100 of FIG. 1.

As in system 100 of FIG. 1, in system 200, a drop-in mounting structure 220 can be used to couple computing component 205 with a mounting surface 215 the computing environment element 210. As shown in this example, the appropriate element of the contact connector 235 can be coupled to a corresponding connection port 207 on the computing component 205 prior to mounting. System 240 of FIG. 2A can illustrate the computing component 205 with the contact connector 235 element attached.

The drop-in mounting structure 220 of system 200, like that of system 100, can utilize two mounting arms 225 having appropriate fastening fingers 230 (or other coupler, as detailed previously). In addition, a support strut 232 can be attached to the mounting surface 215 and the ends of the mounting arms 225. The support strut 232 can provide additional stability for the mounting arms 225 of the drop-in mounting structure 220.

The three-sided structure 220 of FIG. 2 can be formed from a single U-shaped component, in one embodiment. In another embodiment, the three-sided structure 220 can be a three-sided one, where adjacent sides may or may not interconnect. For example, a gap can exist between each of the different sides, which are secured against the mounting surface 215.

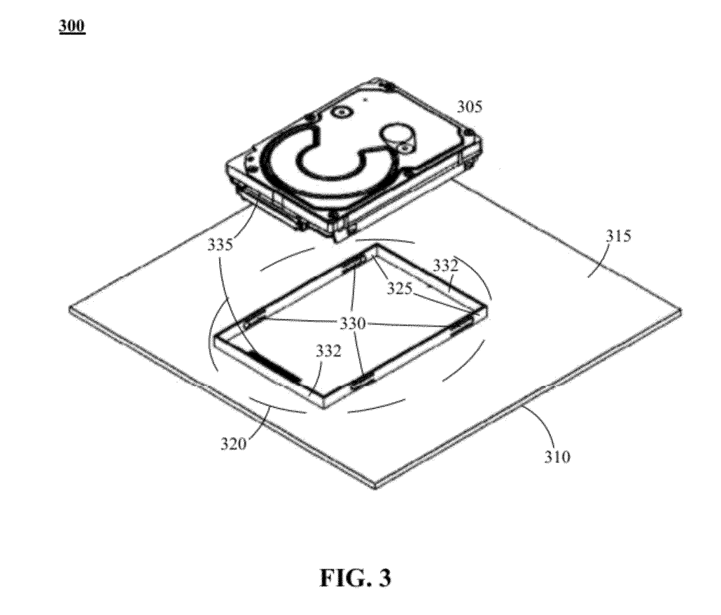

FIG. 3 is a schematic diagram of a system 300 illustrating a four-sided embodiment of the drop-in mounting structure in accordance with embodiments of the inventive arrangements disclosed herein. System 300 can represent a specific embodiment of system 100 of FIG. 1.

As in systems 100 and 200 of FIGS. 1 and 2, system 300 can illustrate the use of a drop-in mounting structure 320 to mount a computing component 305 using a contact connector 335 with the mounting surface 315 of a computing environment element 310.

In this embodiment, the drop-in mounting structure 320 can include two mounting arms 325 having fastening fingers 330 (or other coupler) and two support struts 332. The two support struts 332 can be attached to the two mounting arms 325 at their ends, creating a rectangular structure. The use of the two support struts 332 can provide the most amount of additional stability to the drop-in mounting structure 320.

The three-four structure 320 of FIG. 3 can be formed from a single rectangular-shaped component, in one embodiment. In another embodiment, the four-sided structure 320 can be a four-sided one, where adjacent sides may or may not interconnect. For example, a gap can exist between each of the different sides, which are secured against the mounting surface 315.

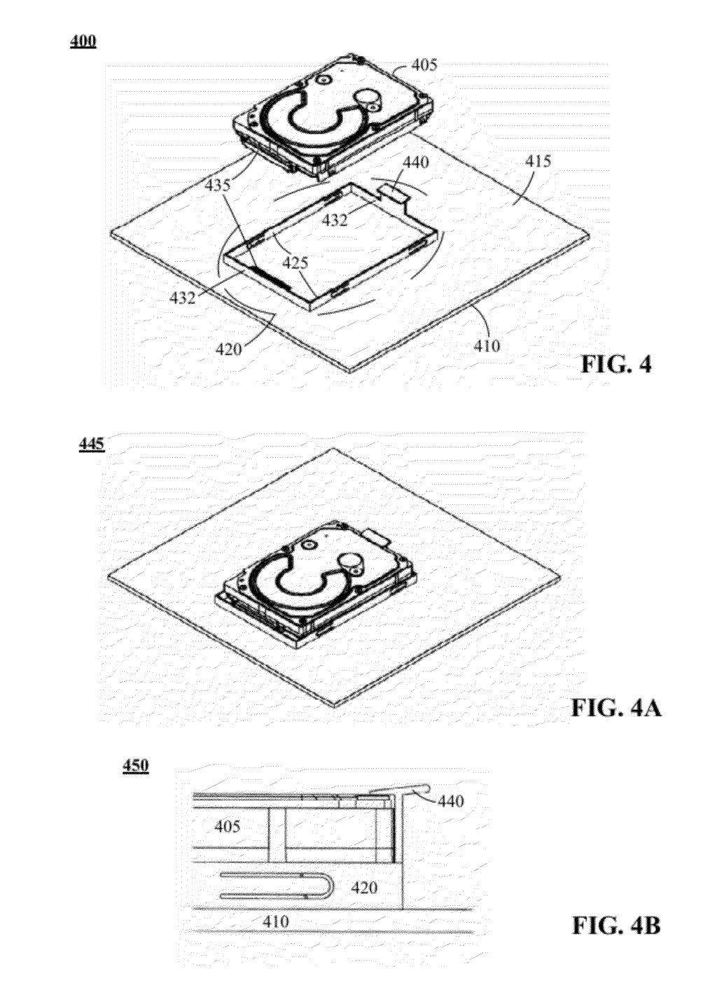

FIG. 4 is a schematic diagram of a system 400 illustrating a drop-in mounting structure 420 with a latching mechanism 440 in accordance with embodiments of the inventive arrangements disclosed herein. System 400 can represent a specific embodiment of systems 100, 200, and/or 300.

In system 400, computing component 405 can utilize a contact connector 435 and a drop-in mounting structure 420 for mounting onto the mounting surface 415 of the computing environment element 410. The drop-in mounting structure 420 of this example can utilize two mounting arms 425 and two support struts 432.

One of the support struts 432 can include a latching mechanism 440. The latching mechanism 440 can be used to secure the computing component 405 within the drop-in mounting structure 420 once placed. The latching mechanism 440 shown in this example can be a tab structure that can overhang onto the top of the computing component 405 once the computing component 405 is mounted, as shown in system 445 of FIG. 4A. Other examples of latching mechanisms 440 can include, but are not limited to, a swing-arm latch, a multi-arm latch, and the like.

An alternative embodiment to that shown as system 400 can have only one support strut 432, which includes the latching mechanism 440. In another embodiment, the latching mechanism 440 can be a stand-alone mechanism, not attached to a strut 432, and the structure 420 can be a two-sided one, such as shown in FIG. 1. In yet another contemplated embodiment, a latch support can arch between two-sides of a two-sided structure, so that the latch is closed after the component 405 is placed on the surface 415 to secure the component 405 to the surface 415.

System 450 FIG. 4B can present a side view of one embodiment for the latching mechanism 458 in use. In system 450, the bottommost layer can represent the computing environment element 410. The drop-in mounting structure 420 can be the layer directly above the computing environment element 410. Pictured between the drop-in mounting structure 420 and the latching mechanism 440 can be the computing component 405.

As shown in this example, the latching mechanism 440, in this case a tab structure, can be of a height to accommodate the height of the computing component 405 when mounted. Additionally, the latching mechanism 440 can be configured to be moveable so as to not interfere with the mounting or removal of the computing component 405.

In another embodiment, the latching mechanism 440 can be an attachment or element of a mounting arm 425. In yet another embodiment, multiple latching mechanisms 440 can be utilized (i.e., one on each support strut 432, one on a support strut 432 and one on a mounting arm 425, etc.).

Another embodiment can utilize multiple latching mechanisms 440 of differing types. That is, a support strut 432 can have a tab structure 440 while a mounting arm 425 can use a swing-arm, such as a locking wire swing-arm.

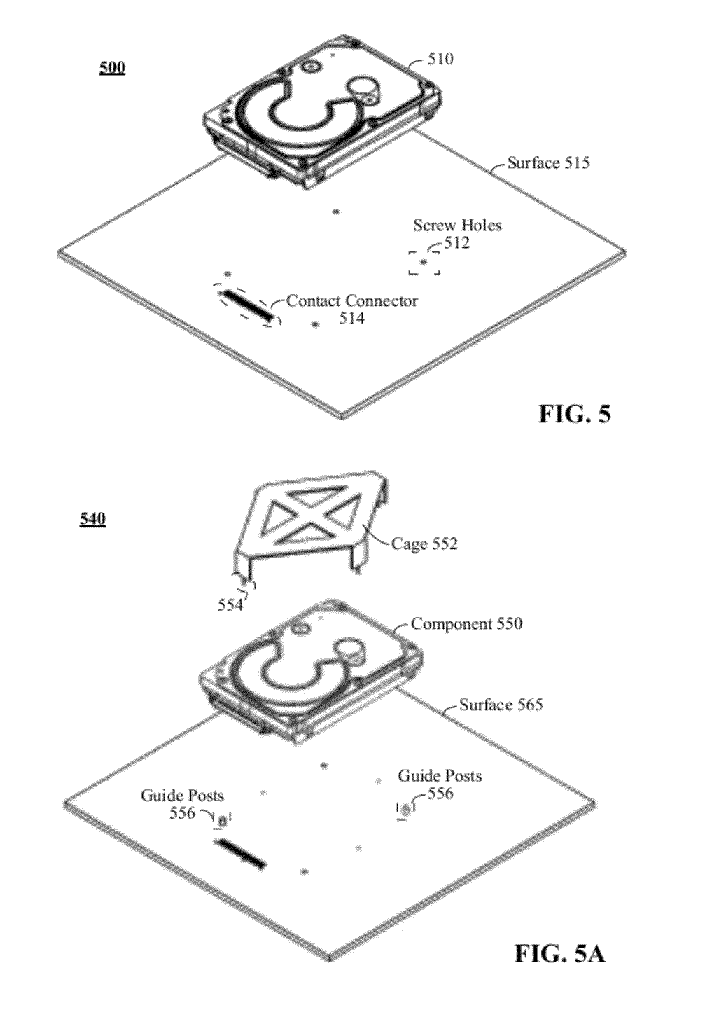

FIG. 5 is a schematic diagram of a system 500 illustrating a drop-in mounting for a computing device 510, which is secured through holes 512 in the mounting surface 515. For example, the holes 512 can be screw holes, which permit screws to be passed through the surface 515 and into corresponding underside holes of component 510. In one embodiment, the holes 512 can be substituted with protrusions, which can be paired to holes in the underside of component 510. In still another embodiment, guide posts (such as guide posts 556) can be included on the mounting surface 515, which can be used to secure component 510 and/or to guide a proper alignment of component 510 relative to surface 515.

In one embodiment, the holes, or other underside support mechanism, can be implemented in conjunction with additional support mechanisms, such as the two-sided structure shown in FIG. 1, the three-sided structure shown in FIG. 2, and/or the four-sided structure shown in FIG. 3.

Embodiment 540 shows a drive cage 552 embodiment, where the cage 552 is able to contain the computing component 550. In one embodiment, one or more guide pins 554 can exist on the cage 552, which can be aligned to screw-holes and/or guide posts 556 of the surface 565. At least two guide pins 554 can be used to achieve a proper alignment along the X and Y planes. Use of four pins can provide additional support. Further, more than four pins can be utilized to couple/align cage 552 to mounting surface 565.

In one embodiment, the pins 554 of the cage 552 can be connectors, which snap to the holes/posts of the mounting surface 565, when placed in correct alignment. Additionally, in one embodiment, the guide posts 554 can be designed to be selectively coupled/decoupled from the mounting surface 565. For example, a flexible tap can be implemented so that when pushed inward (toward computing component 550), the cage 552 (or associated pin 554) can be unhooked or decoupled from the mounting surface 565.

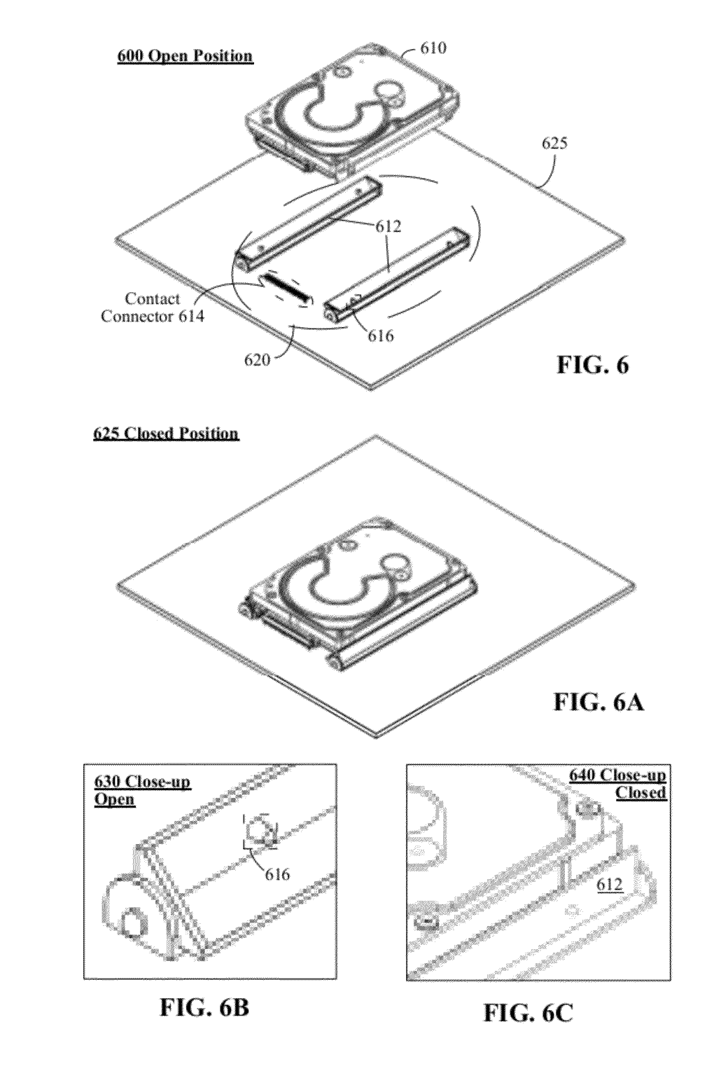

FIGS. 6, 6A, 6B, and 6C shows a schematic diagram of a system showing a pivot mechanism for coupling a computing component 610 to a mounting surface 625 in accordance with an embodiment of the disclosure. More specifically, FIG. 6 shows an open position 600, FIG. 6A shows a closed position 625, FIG. 6B shows a close-up open position 630, and FIG. 6C shows a close-up closed position 640.

As shown in FIG. 6, a computing component 610 can be horizontally dropped in to the pivot connector 620, causing each connector 612 to pivot inwardly. As they pivot, one or more protrusions 616, which may be conical shaped, can be rotated into the mounting holes of the sides of the component 610. As the rotating occurs, the rotating part (connector 612) can be optionally locked into its position. The snap and lock feature can be implemented on component 612 on surface 625, or on component 610. In one embodiment, tabs or other release mechanisms can be placed near the protrusion 616 to ease removal of the component 610 from the closed position 615.

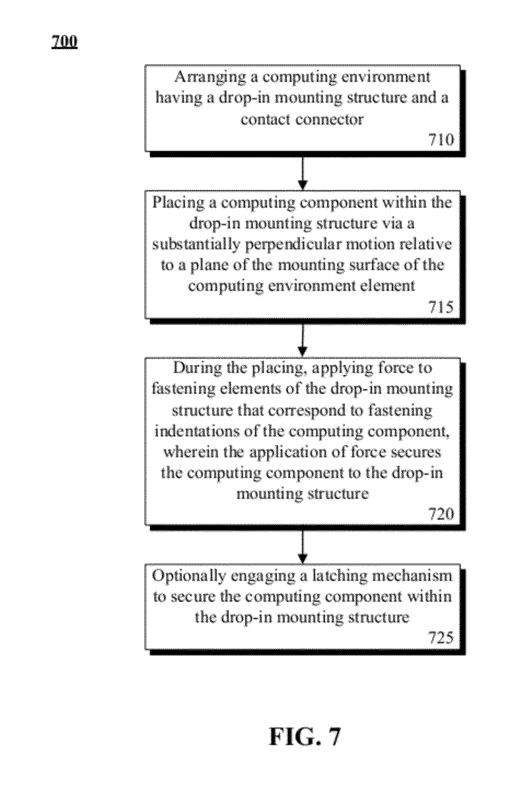

FIG. 7 shows a flow chart of a method 700 for coupling a computing component with a drop-in mounting structure in accordance with an embodiment of the inventive arrangements disclosed herein. Method 700 can be performed in context of system 100, 200, 300, 400, 500, 600, and the like.

The method 700 can begin in step 710, where a computing environment element (e.g., a printed circuit board) can be arranged for placement of a computing component. The computing environment element can have a drop-in-mounting structure designed to physically secure the computing component when attached as well as a contact connector designed to electronically couple the computing component to the computing environment element when attached. In step 715, the computing component can be placed within the drop in mounting structure via a substantially perpendicular motion relative to a plane of the surface of the computing environment element. This placement can be performed manually or by a mechanical assembly device. During the placing of the computing component, a force can be applied to hinged, flexible, or otherwise movable fastening elements of the drop-in mounting structure. The force results in the fastening elements moving to accommodate corresponding fastening indentations of the computing component. The force can secure the computing component to the drop-in mounting structure without soldering, screwing, or other securing mechanism being required. Once properly placed, the contact connector will electronically couple the computing component to the computing environment element.

In optional step 725, a latching mechanism can be additionally utilized to secure the computing component within the drop-in structure. In one contemplated embodiment, no fastening indentation of the computing component or fastening elements are needed, and the latch of step 725 can be sufficient by itself to physically secure the computing device to the computing environment element.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computing component mounting system comprising:
a contact connector configured to provide a solderless connection between a computing component and an element of a computing environment, wherein said contact connector comprises a contact adapter and a contact pad, wherein contact between the contact adapter and the contact pad establishes an electrical interface between the computing component and the computing environment; and
two drop-in mounting arms attached to a mounting surface of the element of the computing environment, wherein said two mounting arms are aligned in parallel to each other at a spacing corresponding to dimensions of the computing component being mounted, wherein each mounting arm comprises a quantity of fastening fingers, wherein the quantity and positioning of said fastening fingers correspond to a quantity and positioning of fastening indentations upon the computing component being mounted, wherein placement of the computing component between the two mounting arms engages the fastening fingers with their corresponding fastening indentations and engages the contact connector.

2. The computing component mounting system of claim 1, further comprising:
a support strut perpendicularly joined to the two mounting arms and attached to the mounting surface of the element of the computing environment, wherein said support strut enforces a vertical stability of the two mounting arms with respect to the mounting surface, and, wherein the support strut is joined to the two mounting arms at corresponding arm ends, whereby creating a U-shaped mounting structure.

3. The computing component mounting system of claim 2, wherein the support strut further comprises:
a latching mechanism for securing the computing component within an area bounded by the two mounting arms and the support strut, wherein movement of the computing component away from a plane defined by the mounting surface is impeded.

4. The computing component mounting system of claim 3, wherein the latching mechanism comprises a tab structure at a height correspondent to a height of the computing component being mounted, wherein physical manipulation of said tab structure frees the computing component for removal from the two mounting arms.

5. The computing component mounting system of claim 1, further comprising:
two support struts each perpendicularly joined to the two mounting arms and attached to the mounting surface of the element of the computing environment, wherein said two support struts enforce a vertical stability of the two mounting arms with respect to the mounting surface, and, wherein each support strut is joined to the two mounting arms at corresponding arm ends, whereby creating a rectangular mounting structure.

6. The computing component mounting system of claim 5, wherein at least one of the two support struts further comprises:
a latching mechanism for securing the computing component within an area bounded by the two mounting arms and the two support struts, wherein movement of the computing component away from a plane defined by the mounting surface is impeded.

7. The computing component mounting system of claim 6, wherein the latching mechanism comprises a tab structure at a height correspondent to a height of the computing component being mounted, wherein physical manipulation of said tab structure frees the computing component for removal from the two mounting arms.

8. The computing component mounting system of claim 1, wherein at least one of the two mounting arms comprises a positioning guide configured to direct placement of the computing component between the two mounting arms so as to engage the fastening fingers within the fastening indentations and engage the contact connector.

9. The computing component mounting system of claim 1, wherein the computing component is an aggregate of at least two computing components bound by a framing structure, wherein dimensions of the aggregate are approximately equal to dimensions of a different individual computing component for which the two mounting arms have been positioned to accommodate, wherein the framing structure comprises fastening indentations that correspond to the different individual computing component.

10. The computing component mounting system of claim 1, wherein each of the two drop-in mounting arms are able to pivot at least fifteen degrees, each drop-in mounting arm comprising a protrusion, which aligns with screw holes in a side of the computing component when pivoted to a closed position.

11. A system for mounting computing components comprising:
an element of a computing environment having at least one connection port;
a computing component having a connector corresponding to a connection port on the element of the computing environment;
a contact connector configured to provide a solderless connection between the computing component and the element of the computing environment, wherein said contact connector comprises a contact adapter and a contact pad, wherein contact between the contact adapter and the contact pad establishes an electrical interface between the computing component and the computing environment; and
a drop-in mounting structure attached to a mounting surface of the element of the computing environment configured to allow placement of the contact connector element attached to the computing component directly upon the contact connector element attached to the mounting surface of the element of the computing environment in a single motion perpendicular to the mounting surface.

12. The system of claim 11, wherein the drop-in mounting structure further comprises:
two drop-in mounting arms attached to the mounting surface of the element of the computing environment, wherein said two mounting arms are aligned in parallel to each other at a spacing corresponding to dimensions of the computing component being mounted, wherein each mounting arm comprises a quantity of fastening fingers, wherein the quantity and positioning of said fastening fingers correspond to a quantity and positioning of fastening indentations upon the computing component being mounted, wherein placement of the computing component between the two mounting arms engages the fastening fingers with their corresponding fastening indentations and engages the contact connector.

13. The system of claim 12, further comprising:
at least one support strut perpendicularly joined to the two mounting arms and attached to the mounting surface of the element of the computing environment, wherein the at least one support strut enforces a vertical stability of the two mounting arms with respect to the mounting surface, and, wherein a support strut is joined to the two mounting arms at corresponding arm ends.

14. The system of claim 13, wherein the at least one support strut further comprises:
a latching mechanism for securing the computing component within an area bounded by the drop-in mounting structure, wherein movement of the computing component away from a plane defined by the mounting surface is impeded.

15. The system of claim 12, wherein at least one of the two mounting arms comprises a positioning guide configured to direct placement of the computing component between the two mounting arms so as to engage the fastening fingers within the fastening indentations and engage the contact connector.

16. The system of claim 11, wherein the computing component is an aggregate of at least two computing components bound by a framing structure, wherein dimensions of the aggregate are approximately equal to dimensions of a different individual computing component for which the drop-in mounting structure has been positioned to accommodate, wherein the framing structure comprises fastening indentations that correspond to the different individual computing component.

17. The system of claim 12, wherein the computing component is at least one of a hard drive and a solid state drive (SSD).

18. The system of claim 11, further comprising:
a cage configured to be placed over the computing component to trap the computing component between the mounting surface and itself, when the cage is mounted to the mounting surface.

19. A method for installing computing components that use contact connectors comprising:
placing a computing component within a drop-in mounting structure having two mounting arms, wherein said two mounting arms are aligned in parallel to each other at a spacing corresponding to dimensions of the computing component upon a mounting surface of an element of a computing environment, and, wherein said placement of the computing component engages a contact connector between the computing component and the mounting surface, whereby an element of the contact connector attached to the computing component is directly situated upon a corresponding element of the contact connector attached to the mounting surface in one action.

20. The method of claim 19, further comprising:
adjusting placement of the computing device within the drop-in mounting structure so as to couple fastening finger elements of the two mounting arms with corresponding fastening indentations on the computing component.

21. The method of claim 19, further comprising:
engaging a latching mechanism to secure the computing component within the drop-in mounting structure, wherein the computing component comprises at least one of a hard drive and a solid state device (SSD).

22. The method of claim 19, wherein the computing component is an aggregate of at least two computing components bound by a framing structure, wherein dimensions of the aggregate are approximately equal to dimensions of a different individual computing component for which the drop-in mounting structure has been positioned to accommodate, wherein the framing structure comprises fastening indentations that correspond to the different individual computing component.
